(19) United States
(12) Patent Application Publication
(10) Pub. No.: US 2010/0103453 A1
(43) Pub. Date: Apr. 29, 2010

(54) PRINTING SYSTEM AND CONTROL METHOD OF THE PRINTING SYSTEM

(75) Inventor: Kensuke Tsutsumi, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/578,571

(22) Filed: Oct. 13, 2009

(30) Foreign Application Priority Data
Oct. 28, 2008 (JP) 2008-277377

(51) Int. Cl. G06F 3/12

(52) U.S. Cl. 358/1.15

(57) ABSTRACT

In a printing system that registers a schedule of print jobs before printing and that executes the print jobs in order of registration, a print server receives a print request of print jobs and requests a print device to register the print jobs. The print server abandons the print jobs after the request of the registration of the print jobs. Meanwhile, the print device that has received the registration of the print jobs registers the print jobs in the schedule, and the print device instructs the print server to execute the print jobs according to the schedule. The print server acquires the instructed print jobs, generates print data based on the print jobs, and transfers the print data to the print device.

### BACKGROUND OF THE INVENTION

1. Field of the Invention

The present invention relates to a printing system and a control method of the printing system.

2. Description of the Related Art

Conventionally, a technique for balancing printing processes in a plurality of print servers has been proposed (see, for example, Japanese Patent Laid-Open No. 2006-313442).

According to Japanese Patent Laid-Open No. 2006-313442, a management server that allocates printing processes to print servers occupies the logical device and distributes print requests to the print servers. In the disclosed technique, print data is acquired in the order of distribution to the print servers, and the data is delivered to print devices for printing.

If one print server controls a large amount of print jobs to deliver data for printing to thousands of print devices located in offices across the nation, a heavy load is imposed on the print server, and a great amount of time is required before the jobs are discharged. To prevent this, a plurality of print servers must be clustered to balance the load (perform load balancing) for operation. The printing system is balanced by the cluster configuration, and print information, such as job information and printer information, common to the print servers is intensively managed on a common disk.

However, printing processes may be concentrated on a large-scale print server system. An example of a requirement for a print server system to handling such processing includes print order control. During print execution from the print server to the print devices, the print devices and the print server are in a one-to-one relationship. Therefore, one print server must consecutively perform printing according to the printing order of the given print device.

Thus, when print requests are concentrated on one print device, only one print server processes the requests, and the printing processes are concentrated on one print server.

The merit of clustering is lost when the load is concentrated. It may take a long time to print the jobs by which printing is requested of the print server with a concentrated load and the print performance of the print server system may be degraded.

Even if the print order is controlled by the method of Japanese Patent Laid-Open No. 2006-313442, the print server that executes a printing process for a specific print device is fixed. Therefore, if print requests are concentrated on one print device, the load of one print server increases, and the problem of the printing process concentration cannot be solved.

### SUMMARY OF THE INVENTION

The present invention provides a printing system and a control method of the printing system for printing in a specified print order without printing processes being concentrated on one print server.

According to one aspect of the present invention, there is provided a printing system that registers a schedule of print jobs and that executes the print jobs in order of registration, the system comprising a print server and a print device, wherein

the print server has a unit that receives a print request of print jobs and requests a print device to register the print jobs, and a unit that abandons the print jobs after the request of the registration of the print jobs;

the print device has a unit that registers the schedule of the print jobs after the print device receives the registration of the print jobs, and a unit that instructs the print server to execute the print jobs according to the schedule; and

the print server further has a unit that acquires the instructed print jobs, generates print data based on the print jobs, and transfers the print data to the print device.

According to another aspect of the present invention, there is provided a control method of a printing system that registers a schedule of print jobs and that executes the print jobs in order of registration, the method comprising:

receiving, in a print server, a print request of print jobs and requesting a print device to register the print jobs;

abandoning, in the print server, the print jobs after the request of the registration of the print jobs;

registering, in the print device that has received the registration of the print jobs, the schedule of the print jobs;

instruction, by the print device, of the print server to execute the print jobs according to the schedule; and

in the print server, acquiring the instructed print jobs, generating print data based on the print jobs, and transferring the print data to the print device.

Further features of the present invention will become apparent from the following description of exemplary embodiments with reference to the attached drawings.

### BRIEF DESCRIPTION OF THE DRAWINGS

FIG. 1 is a block diagram showing an example of a configuration of a printing system in the present embodiment;

FIG. 2 is a diagram showing an example of a hardware configuration of a server computer or a client computer;

FIG. 3 is a diagram showing an example of job information managed by a DBMS in the present embodiment;

FIG. 4 is a diagram showing an example of device information managed by the DBMS in the present embodiment;

FIG. 5 is a diagram showing an example of document information managed by the DBMS in the present embodiment;

FIG. 6 is a block diagram of an example of a configuration of a print server system 101;

FIG. 7 is a diagram showing an example of a hardware configuration of a print device 107;

FIG. 8 is a diagram showing a hierarchical configuration of the print device 107;

FIG. 9 is a block diagram of a configuration of a schedule application;

FIG. 10 is a diagram showing schedule information of print jobs managed by a job manager 902;

FIG. 11 is a diagram showing information related to a maximum number of consecutive print jobs managed by a device manager 903;

FIG. 12 is a flow chart showing a process when a print server 601 receives a print request;

FIG. 13 is a flow chart showing a process when a schedule application 801 receives a schedule request from the print server 601;

FIG. 14 is a flow chart showing a process when the schedule application 801 instructs printing to the print server 601;

FIG. 15 is a flow chart showing a process of the print server 601 after receiving the print instruction from the schedule application 801;

FIG. 16 is a diagram showing a sequence during schedule registration between the print server 601 and the schedule application 801;

FIG. 17 is a diagram showing a print sequence between the print server 601, a load balancer 602, the schedule application 801, and a device controller 810;

FIG. 18 is a flow chart showing processing of the schedule application 801 when the print server 601 notifies it of the start of transfer of print data;

FIG. 19 is a flow chart showing processing when the schedule application 801 receives a printing result from the device controller 810;

FIG. 20 is a flow chart showing processing when the print server 601 receives a printing result notification from the schedule application 801; and

FIG. 21 is a flow chart showing processing of the schedule application 801 when a session disconnection between the print server 601 and the schedule application 801 is detected before a transfer end is notified.

### DESCRIPTION OF THE EMBODIMENTS

Preferred embodiments of the present invention will now be described in detail with reference to the drawings.

<System Configuration>

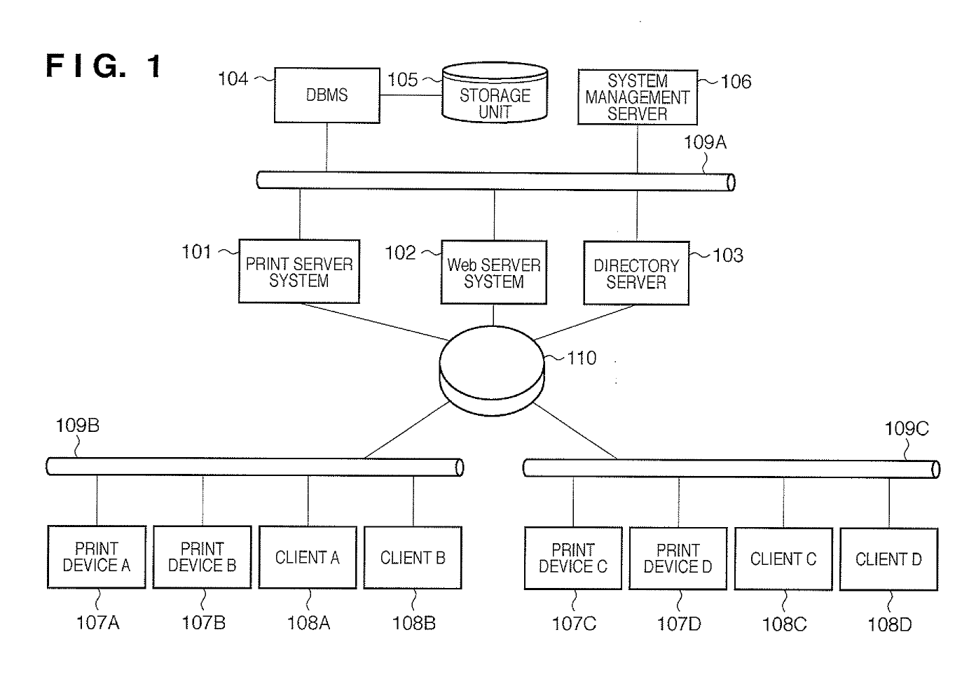

FIG. 1 is a block diagram showing an example of a configuration of a printing system in the present embodiment. In FIG. 1, a server computer system for controlling a plurality of printing systems, print devices, and client computers are connected through a WAN (Wide Area Network) 110 and spread through a wide area.

A DBMS (DataBase Management System) 104 is a server computer system for managing data, such as document data, print jobs, and printer information, stored in a storage unit 105. The DBMS 104 receives operations, such as update, retrieval, addition, and deletion, of various data from other servers and executes the operations. A cluster configuration for load balancing may be implemented in the case of a large-scale printing system, or a redundant system configuration may be implemented for fault tolerance.

The storage unit 105 may be directly connected to the DBMS 104 as a DAS (Direct Attached Storage) or connected through a network as a SAN (Storage Area Network).

A print server system 101 is a server computer system that manages monitoring and managing of print devices in the printing system, controlling and monitoring print jobs, and transferring the print jobs to print devices. In case of a large-scale printing system, the print server system 101 also has a cluster configuration for load balancing or a redundant cluster configuration. The print server system 101 is connected to the DBMS 104 or a Web server system 102 described below through a LAN (Local Area Network) 109A to exchange print job data, print control instructions, information of managing print jobs, and the like.

The Web server system 102 transmits job information and document information managed by the DBMS 104 to a plurality of front-end clients 108 connected through the WAN 110. The Web server system 102 is a server computer system and usually has a cluster configuration or a redundant configuration for load balancing in case of a large-scale printing system. The Web server system 102 receives print instructions and operations of print jobs from the clients 108 and transfers the instructions to the print server system 101.

The Web server system 102 also manages the authentication of login from clients 108 and print devices 107 in collaboration with a directory server 103 described below. The Web server system 102 holds user authorization information that is set in advance by the system designer or the document creator. Examples of authorization information include reference, print, and delete authorization of documents, print authorization for certain printers, and delete authorization of print jobs. The Web server system 102 may store and manage the authorization information of user, or the DBMS 104 may store and manage user authorization information.

The directory server 103 is a server that manages user authentication via a combination of user name and password. Users may be able to participate in domain groups, and the authorization of users within a domain group may be set in a different range from the authorization of single users. Users may be able to participate in a plurality of domain groups.

The system management server 106 is a server that manages systems such as the print server system 101, the Web server system 102, and the directory server 103.

Print devices 107 (107A, 107B, 107C, and 107D) are printing devices. The print devices 107 are connected to a LAN 109B or a LAN 109C through network interfaces not shown. The LANs 109B and 109C are connected to the WAN 110, and the print devices 107 are configured to be able to communicate with the print server system 101 and the Web server system 102 described above through the LAN and the WAN.

Laser beam printers implementing an electrophotographic system or inkjet printers implementing an inkjet system can be appropriately applied as the print devices 107. The print devices 107 comprise schedule applications that manage print schedules described below.

The clients 108 (108A, 108B, 108C, and 108D) are client computers that process information. The clients 108 are connected to the LAN 109B or the LAN 109C through network interfaces not shown and are configured to be able to communicate with various server systems through the WAN 110. The clients 108 may be computers connected with persistent storage or may have Thin Client configurations comprising only temporary storage.

<Hardware Configurations of Server Computer and Client Computer>

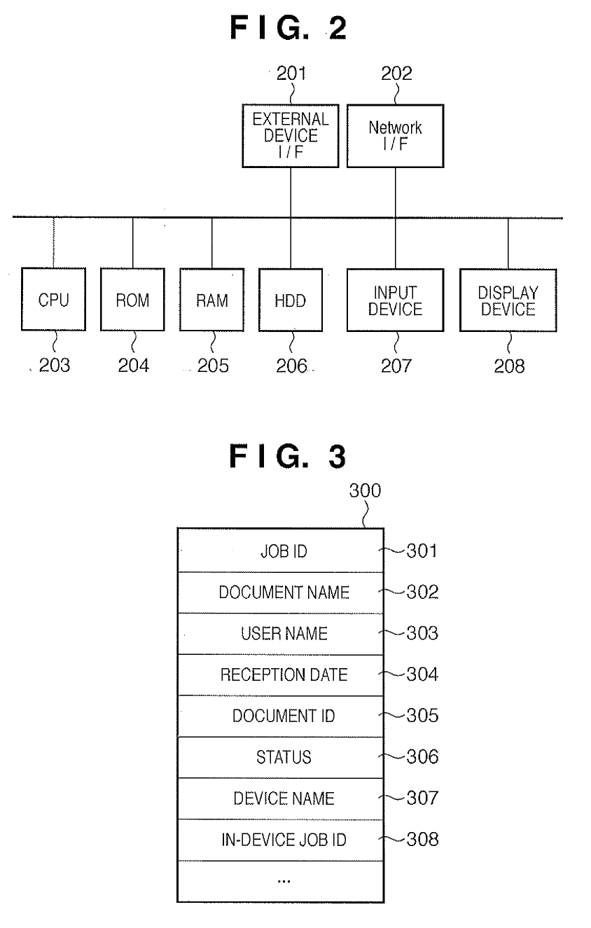

FIG. 2 is a diagram showing an example of a hardware configuration of a server computer or a client computer. A CPU 203 loads a program stored in an HDD 206 into a RAM 205, executes a process according to the program, and controls the present apparatus (server computer or client computer). A ROM 204 is a non-rewritable memory that stores programs and control data related to the processes of the present apparatus. The RAM 205 is a rewritable memory that stores temporary data related to the processes of the present apparatus.

The programs, the control data, the temporary data, and the like, related to the processes of the present apparatus are also stored in the HDD 206.

An input device 207 is a keyboard or a pointing device that accepts instruction input to the present apparatus. A display device 208 displays the operation status of the present apparatus or information output by the programs operated on the present apparatus. A Network I/F 202 is an interface that is connected to the LAN and the Internet through a network and that exchanges information with the outside. An external device I/F 201 is an interface for connecting an external storage, or the like.

<Web Server System>

As described, the Web server system 102 usually has a cluster configuration for load balancing and is comprised of a plurality of Web servers. The Web server is a server for communicating information in a WWW (World Wide Web) system and is software. The Web server system 102 includes the following functions.

The user account information and the password are obtained by the login from the front-end clients 108 to ask the directory server 103 for authentication. If the login authentication succeeds, the reference authorization of document of the user is approved. Information of the document is acquired from the DBMS 104 according to the approved reference authorization, and the information is transmitted to the client 108 that is logging in. When printing of a document is instructed by clients 108, the print instruction is transmitted to the print server system 101.

Examples of the approval policy of the reference authorization include a policy whereby documents of all users belonging to the domain can be referenced and a policy that only the user's documents can be referenced. A flexible design can be made depending on the policy of the user who implements the printing system. In the approval, not only the reference of document, but also authorizations, such as print authorization of document, delete authorization of print job, and promote authorization, can be set.

<DBMS>

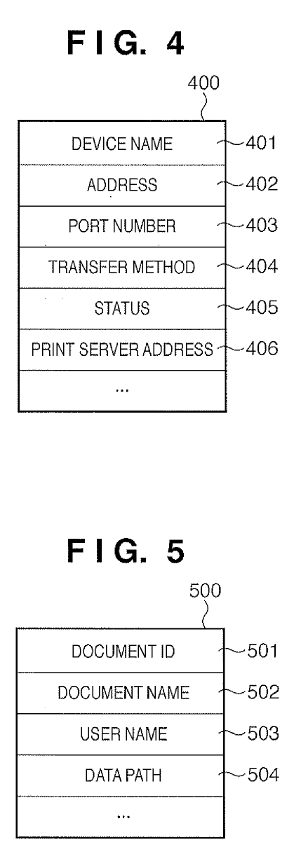

Various data management methods, such as card-type, relational-type, and object-type, can be selected for the DBMS 104. The DBMS 104 is a relational-type, which is most widely used, in the description of the present embodiment. The DBMS 104 holds table information in the storage unit 105, such as job information 300 (FIG. 3), device information 400 (FIG. 4), and document information 500 (FIG. 5).

FIG. 3 is a diagram showing an example of job information managed by the DBMS in the present embodiment. As shown in FIG. 3, the job information 300 includes a job ID 301, a document name 302, a user name 303, a reception date 304, a document ID 305, a status 306, a device name 307, and an in-device job ID 308. The user name 303 is an account name of the user who has instructed printing. The document ID 305 is an identifier of document managed by the DBMS 104. The status 306 is a print job status.

The status includes a “transferring” state in which print data is being transferred to the print device 107, a “printing” state in which the print device 107 is printing, and a “schedule standby” state whereby printing is on hold.

The device name 307 is the name of a print device 107 that performs printing. The in-device job ID 308 is an identifier of a job issued by a schedule application (details will be described below with reference to FIG. 8) in the print device 107.

FIG. 4 is a diagram showing an example of device information managed by the DBMS in the present embodiment. Various pieces of information of the print devices 107 that will perform printing are held as device information 400. As shown in FIG. 4, the device information 400 includes a device name 401, a destination address of device 402, a port number 403 used for communication, a transfer method of print data 404, a status of device 405, and a print server address 406.

Examples of the transfer method of print data 404 include RAW for consecutive transmission of data as a stream based on TCP/IP, LPR (Line PRinter daemon protocol), and a method of transmission via HTTP.

A device manager of the print server system 101 may manage the device information 400, and the data may be held in any location.

One of the addresses of a plurality of print servers in the print server system 101 is registered in the print server address 406. When an address is registered in the print server address 406, the print server is processing a print request. The print server registered in the print server address 406 occupies the schedule registration to follow the printing order in the print devices 107.

FIG. 5 is a diagram showing an example of document information managed by the DBMS in the present embodiment. As shown in FIG. 5, document information 500 includes a document ID 501 as an identifier of a document, a document name 502, a user name 503 of a user who has registered document, and a data path 504 indicating the actual location where the document is stored. In the present embodiment, a reference is held as the document information 500. Although data is stored in a separate location, the data may be directly held.

The DBMS 104 is used, for example, in the following process.

(1) Acquire all document information and job information matching the user name designated from the Web server system 102.

(2) Acquire device information matching the device name designated from the Web server system 102.

(3) Acquire information of document matching a document ID designated from print server 601.

(4) Acquire device information necessary for printing from the print server 601.

(5) Register a new document and a job from the print server 601.

(6) Update job status and device status from the print server 601 when the state of job or device changes.

<Print Server System>

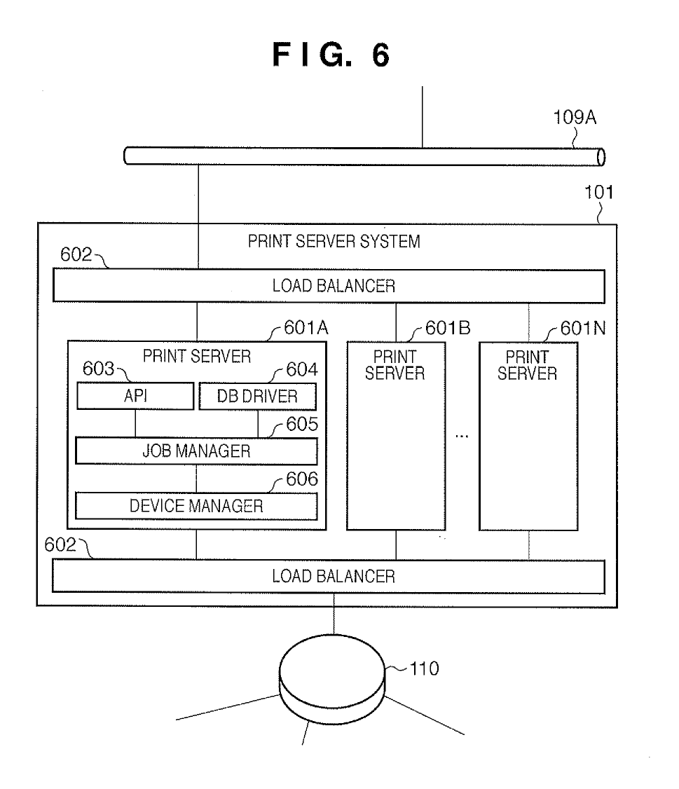

FIG. 6 is a block diagram showing an example of a configuration of the print server system 101. In FIG. 6, a load balance configuration is implemented in the print server system 101 to treat a large-scale printing system. A plurality of print servers 601 is connected to the LAN 109A and the WAN 110 through a load balancer 602 as a switch mechanism for load balancing. The load balancer 602 determines the load conditions of a plurality of print servers 601 and balances the load so that a request is issued preferentially to a server without load.

Examples of the method for determining the load conditions include a method called round robin in which requests are simply and sequentially passed to the servers and a method of periodically transmitting a specified request to a plurality of print servers 601 and determining the time until the reply as the load.

A schematic configuration of the print server 601 will be described next. The print server 601 is comprised of an API 603, a DB driver 604, a job manager 605, and a device manager 606. API stands for Application Program Interface. The API 603 receives document registration from the Web server system 102 and other servers that generate printable documents, a print request of a document, and a control request of a print job. Examples of the other servers that generate printable documents include a business form server that creates stylized business forms and a document management server that collectively manages user documents.

When the API 603 receives a print request, the device information 400 held by the DBMS 104 is specified by the request information, and the address of the print server is registered in the print server address 406. The print server address 406 is cleared upon the print request CB (Call Back). If another print server address is already registered upon the registration of the print server address 406, the print request is transferred to the print server address.

The DB driver 604 is a module that communicates with the DBMS 104. The DB driver 604 receives a document registration request to register the document in the DBMS 104 and receives a print request to acquire print data from the DBMS 104.

The job manager 605 has the following functions. A document received by the API 603 is registered in the DBMS 104 through the DB driver 604. When the API 603 receives a print request, information of document to be printed by the DBMS 104 is referenced through the DB driver 604 to determine whether printing is possible. If printing is possible, the job manager 605 instructs the device manager 606 to register the schedule in the schedule application.

After the device manager 606 registers the schedule, the job manager 605 receives notification from the device manager 606. Information received by the print request information and the schedule registration CB is registered in the DBMS 104 as the job information 300. After the registration in the DBMS 104, the job information does not have to be held in the print server 601 and is abandoned.

A process of the device manager 606 will now be described. The device manager 606 acquires and temporarily stores (caches) the device information 400 held by the DBMS 104. The device information 400 cached by the device manager 606 is used in printing. The device information 400 may be acquired each time printing is started or may be periodically acquired, and the cache of the device information 400 may be updated at any time.

The device manager 606 receives a schedule registration request of job from the job manager 605 and starts communicating with the schedule application in the print device 107 to register the schedule. When the schedule registration is completed and the schedule registration CB is received from the schedule application, the device manager notifies the job manager 605 of the schedule registration CB information. Details of the schedule registration sequence will be described later.

After receiving a print instruction from the job manager 605, the device manager 606 acquires document data based on the schedule information received with the print instruction. The device manager 606 then uses the cache of the holding device information 400 to convert the document data into a format printable by the print device 107 and starts transferring the print data to the print device 107. Formats printable by the print device 107 include PDL (Page Description Language) and PDF (Portable Document Format).

The format conversion is not necessary in some cases such as when the print device 107 has a direct PDF printing function whereby PDF documents can be directly received and printed. Details of the print sequence from the device manager 606 receiving the print instruction and transferring the print data to the print device 107 to the completion of printing will be described later.

The device manager 606 also has a function of receiving a printing result from the schedule application. The device manager 606 receives a printing result from the schedule application and registers the printing result in the DBMS 104 through the DB driver 604.

<Hardware Configuration of Print Device>

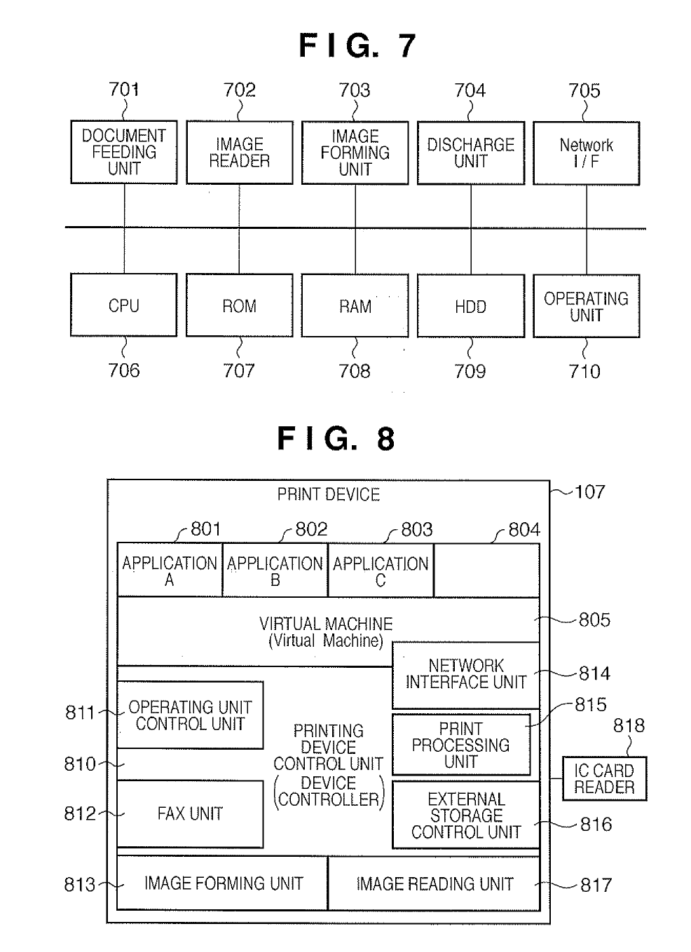

FIG. 7 is a diagram showing an example of a hardware configuration of the print device 107. An image reader 702 reads a document via a document feeding unit 701. An image forming unit 703 converts the read document or data received through the network into a print image and prints and outputs the image. A discharge unit 704 discharges the printed and output paper and executes processing such as sorting and stapling. A Network I/F 705 is an interface that is connected to the LAN or the Internet through the network to exchange information with the outside.

A CPU 706 loads a program stored in a ROM 707 or an HDD 709 into a RAM 708 and executes a process according to the program to control the present device (print device). The non-volatile ROM 707 is a memory for storing programs and data related to the processes of the present device. The rewritable RAM 708 is a memory for storing temporary data related to the processes of the present device. The HDD 709 stores programs and data related to the processes of the present device, temporary data, and the like. An operating unit 710 displays a screen described below and receives an operation instruction of the user through the screen.

<Print Device>

FIG. 8 is a diagram showing a hierarchical configuration of the print device 107. In FIG. 8, an image forming unit 813 executes a series of image forming processes, such as paper handling, image transfer, and fixation, and forms an image on a recording medium such as recording paper. The image forming unit 813 comprises, for example, an inkjet or electrophotographic image forming unit.

An image reading unit 817 comprises a scanner, or the like, and optically reads and converts a document image into digital image information. The image reading unit 817 outputs the digital image information to the image forming unit 813 to form an image and transfers and transmits the information to a fax unit 812, a network interface unit 814, or the like, through a line.

The device controller 810 controls operations of the image forming unit 813 and the image reading unit 817 and controls the image forming unit 813 to copy, for example, the document information read by the image reading unit 817. The device controller 810 also includes the network interface unit 814, a print processing unit 815, the fax unit 812, and an operating unit control unit 811 and controls the information exchange between the components.

The fax unit 812 executes processes such as transmitting and receiving a facsimile image, that is, transmitting digital image information read by the image reading unit 817, or conversely, decoding a received facsimile signal and recording the signal by the image forming unit 813.

The operating unit control unit 811 generates a signal according to an operation by the user who has used an operation panel of an operating unit not shown or controls to display various data, messages, and the like, on the operating unit (or display unit), or the like. The print processing unit 815 executes control such as processing the print data input through the network interface unit 814 and outputting the print data to the image forming unit 813 for printing. The network interface unit 814 controls transmission and reception of data to and from other communication terminals through communication lines.

A virtual machine 805 is located above the device controller 810. The virtual machine 805 is configured to be able to control the device controller 810.

The device controller 810 and the virtual machine 805 can directly use the network interface unit 814 and can independently access external networks.

Above the virtual machine 805, there are applications 801 to 803 described in a programming language corresponding to the API provided by the virtual machine 805. The applications 801 to 803 can indirectly act on the device controller 810 through the virtual machine 805 and can operate the image forming unit 813 and the image reading unit 817.

In the present embodiment, a schedule application is particularly included as the application 801. The applications 801 to 803 can be uninstalled from the virtual machine 805, or an application 804 can also be further installed.

Although the applications 801 to 803 are installed on the print device 107 in the description of the present embodiment, the applications 801 to 803 may be included as hardware. The applications 801 to 803 may also be included as applications on an external device (computer) communicably connected to the print device 107.

An external storage control unit 816 converts an image read by the image reading unit 817 into a data format that can be stored in an external storage by the image forming unit 813 and stores the image in the external storage. The external storage control unit 816 also reads out data stored in the external storage to execute a printing process through the image forming unit 813 or to perform network transmission to the outside through the network interface unit 814.

In the present embodiment, an IC card reader 818 is communicably connected as login means to the print device 107. It is obvious that other means can be used as the login means, and for example, input can be made from a device panel managed by the operating unit control unit 811.

<Schedule Application>

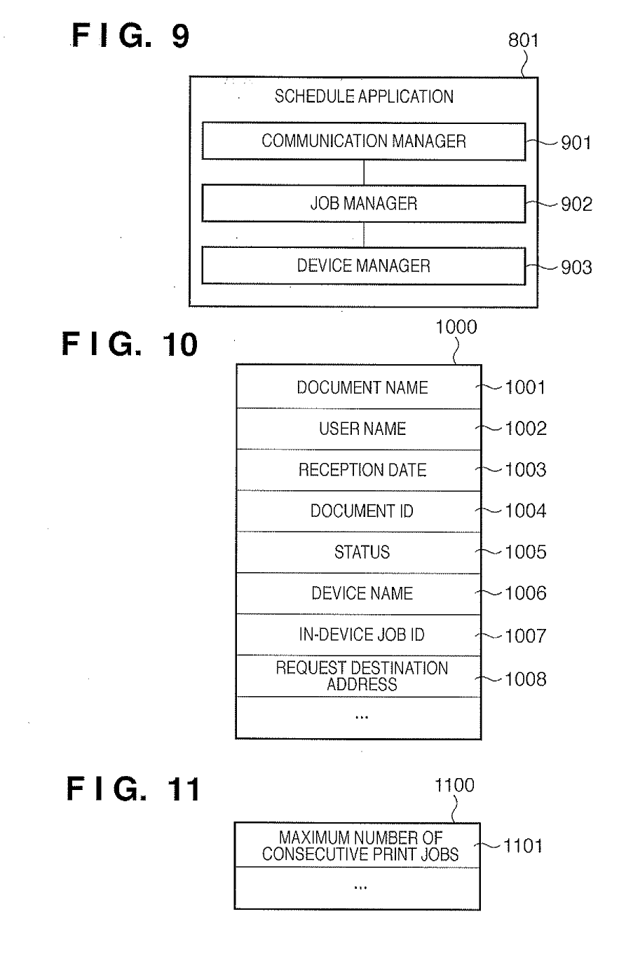

FIG. 9 is a block diagram showing a configuration of a schedule application. The schedule application 801 is comprised of a communication manager 901, a job manager 902, and a device manager 903.

The communication manager 901 receives a connection or request from the print server 601 and notifies a status change of print job notified from the device controller 810. The job manager 902 holds schedule information received from the print server 601 as a schedule list and controls a module that manages print jobs to perform printing in order of registration in the schedule list. The job manager 902 also receives operations, such as deletion and promotion (priority change) of print jobs, from the print server 601 to control the print jobs. Details of the deletion and promotion of print jobs are not related to the present invention and will not be described.

The device manager 903 is a module that communicates with the device controller 810. The device manager 903 deletes print jobs and catches a change in the state of print jobs.

FIG. 10 is a diagram showing schedule information of print jobs managed by the job manager 902. Schedule information 1000 includes a document name 1001, a user name 1002, a reception date 1003, a document ID 1004, a status 1005, a device name 1006, an in-device job ID 1007, and a request destination address 1008.

The schedule information 1000 is information basically common to the job information 300 managed by the DBMS 104, and a detailed description will not be repeated. However, “requested” indicating that printing is instructed to the print servers 601 increases in the status 1005.

FIG. 11 is a diagram showing information related to a maximum number of consecutive print jobs managed by the device manager 903. Consecutive print job limit information 1100 includes a maximum number of consecutive print jobs 1101. The schedule application 801 instructs the print servers 601 to print a plurality of jobs, and the print servers 601 consecutively transfer a plurality of print data in the same session. The maximum number of consecutive print jobs 1101 indicates the maximum number of jobs.

The maximum number of consecutive print jobs 1101 is the maximum number of jobs printed by the print server 601 on one occasion, and the maximum number of consecutive print jobs 1101 can adjust the load balance status of each print server 601. In this way, the performance of the printing process can be optimized by adjusting the maximum number of consecutive print jobs 1101 depending on the performance or the number of print servers 601 load-balanced in the print server system 101.

A print flow of the printing system in the present embodiment comprising the configuration described above will now be described in detail.

<Print Request Reception Flow of Print Server 601>

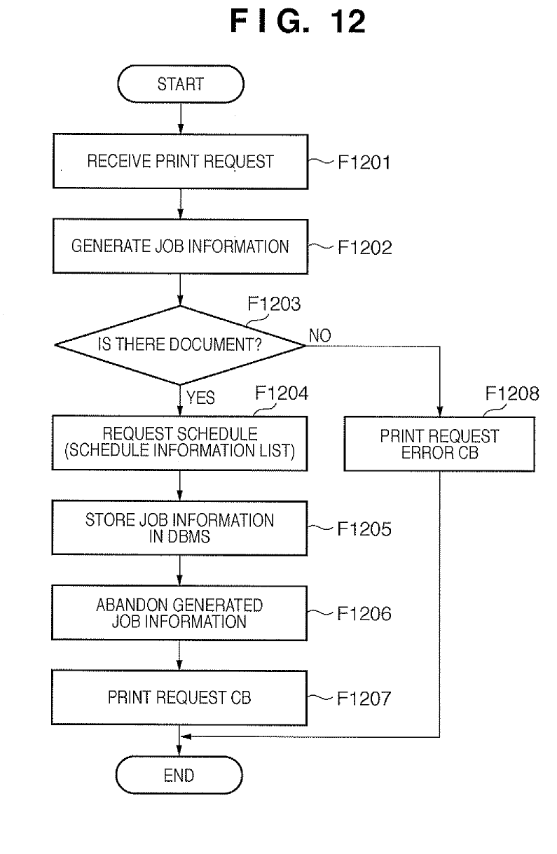

FIG. 12 is a flow chart showing a process when the print server 601 receives a print request. The API 603 in the print server 601 first receives a print request (F1201). The print request includes notification of the document ID and the name or address of the printer that will perform printing. Based on this document ID, the job manager 605 acquires the document information 500 from the DBMS 104 through the DB driver 604 and generates job information (F1202). Although the generated job information is the same information as the job information 300 held by the DBMS 104, the in-device job ID 308 issued from the schedule application 801 is not determined yet.

The existence of document data is checked based on the document information acquired in F1202 to determine whether printing is possible (F1203). If there is no document data, it is determined that printing is impossible, and an error is returned as a print request CB to the print request (F1208).

On the other hand, if there is document data, it is determined that printing is possible. A print device 107 that prints the document data is specified, and a schedule request is issued to the schedule application 801 (F1204). A schedule information list included in the schedule request is generated from the job information generated in F1202 and the request destination address.

In the present embodiment, the address of the load balancer 602 is designated as the request destination address. The designation of the request destination address is fixed to the address of the load balancer 602, and the load balancer 602 takes charge of the load balancing. Addresses of a plurality of print servers 601 can be allocated to the request destination address, and the addresses can be registered. In this way, the load can be balanced without using the function of the load balancer 602.

The schedule application 801 registers the schedule based on the schedule request of F1204 and returns the schedule registration CB. The schedule registration CB includes the in-device job ID issued by the schedule application 801.

The in-device job ID and the job information received by the schedule registration CB are then stored in the job information 300 of the DBMS 104 (F1205). The print server 601 occasionally updates the status 306 of the job information 300 stored in the DBMS 104. The Web server system 102 can refer to the job information 300 held by the DBMS 104 to transmit the job execution status to the user.

After the job information 300 is stored, the print server 601 abandons the job information generated in F1202 for use in the schedule registration (F1206). The job information necessary in printing can be received as information when the print instruction from the schedule application 801 is received, and therefore, the print server 601 does not have to keep holding the job information.

In F1207, the print server 201 returns the print request CB as the print request reception is completed. This completes the print request reception of the print server 201.

<Schedule Registration Operation Flow of Schedule Application 801>

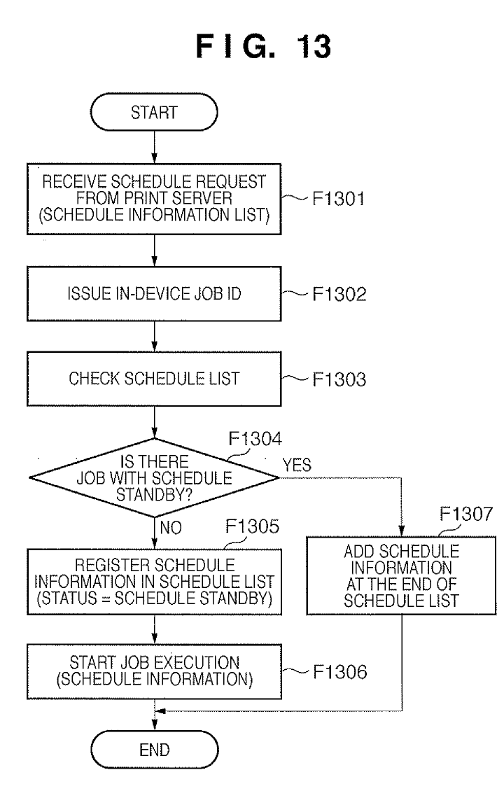

FIG. 13 is a flow chart showing a process when the schedule application 801 receives a schedule request from the print server 601. The communication manager 901 of the schedule application 801 receives a schedule request and notifies a schedule information list, which is transferred when the schedule request is received, to the job manager 902 (F1301). The job manager 902 that has received the schedule information list issues in-device job IDs to all jobs registered in the schedule information list (F1302).

The schedule list managed by the job manager 902 is checked (F1303), and whether there is a job whose status 1005 is schedule standby is checked (F1304). If there is already a job whose status is schedule standby in the schedule list, the schedule information list received by the schedule request is added at the end of the schedule list (F1307), and the process ends.

On the other hand, if there is no job whose status is schedule standby in the schedule list, the schedule information list received by the schedule request is registered in the schedule list, and the status 1005 is set to schedule standby (F1305). The job execution is started based on the schedule information at the top of the schedule information list (F1306). Details of the job execution start will be described below.

In this way, the schedule application 801 receives a schedule request from the print server 601 and registers the schedule information list.

<Job Execution Start Flow of Schedule Application 801>

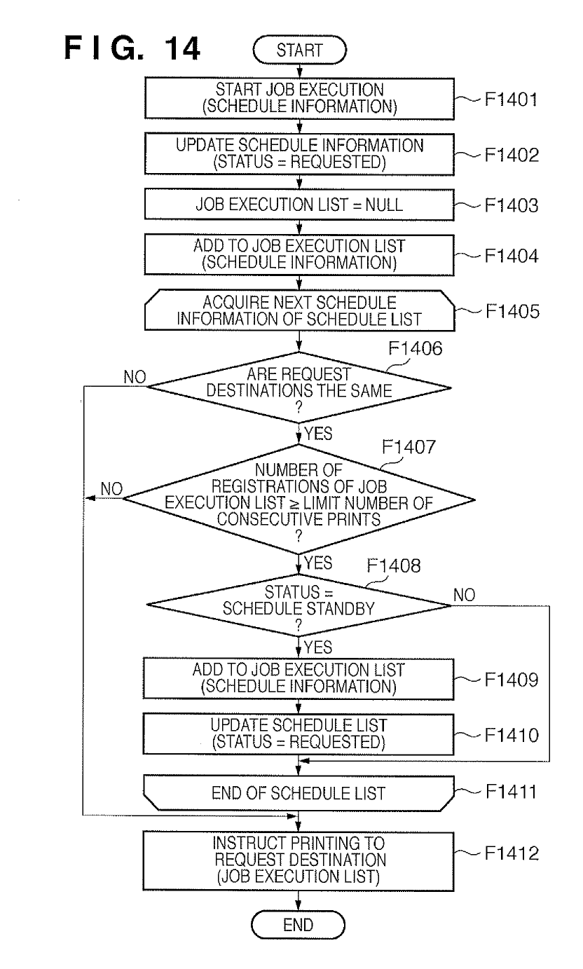

FIG. 14 is a flow chart showing a process when the schedule application 801 instructs printing to the print server 601. The schedule application 801 is first notified of job execution start by the schedule information 1000 registered in the schedule list managed by the job manager 902 (F1401). The status 1005 of said schedule information is updated to “requested” (F1402). The job execution list of which notification is made to the print server 601 upon the print instruction is initialized to “NULL” (F1403), and the schedule information started with the job execution is added to the job execution list (F1404).

In the schedule list managed by the job manager 902, the process is repeated for the next schedule information of the schedule information started with the job execution up to the end of the schedule list (F1405 to F1411).

Whether the request destination address 1008 is the same as the request destination address of the schedule information list started with the job execution is first determined (F1406). If the request destination addresses are different, consecutive printing cannot be performed, and the process of F1405 to F1411 ends.

On the other hand, if the request destination addresses are the same, the print server 601 can perform consecutive printing, and the number of consecutive print jobs of the print server 601 is limited. Thus, whether the number of registrations of the job execution list held by the schedule application 801 is greater than or equal to the maximum number of consecutive print jobs 1101 is determined. If the number of registrations of the job execution list is greater than or equal to the maximum number of consecutive print jobs 1101 as a result of the determination, there will be no more registrations in the job execution list, and the process of F1405 to F1411 ends.

On the other hand, if the number of registrations is not greater than or equal to the maximum number of consecutive print jobs 1101, the schedule information is added to the job execution list as consecutive printing is possible (F1409). The status 1005 of the added schedule information is updated to “requested” (F1410).

When processing of the entire schedule information list registered in the schedule list is finished (F1411), a print instruction is issued to the request destination address 1008 in the job execution list (F1412). A sequence between the schedule application 801 and the print server 601 to instruct printing will be described later.

In this way, the schedule application 801 instructs printing to the print server 601.

<Print Flow of Print Server 601>

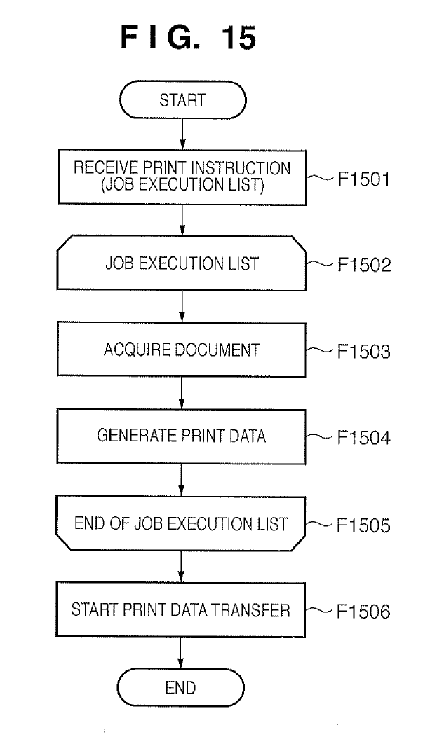

FIG. 15 is a flow chart showing a process of the print server 601 after receiving the print instruction from the schedule application 801. The print instruction from the schedule application 801 includes the job execution list, and a plurality of pieces of schedule information 1000 is registered.

When the print server 601 receives the print instruction, the entire schedule information list registered in the job execution list is executed (F1502 to F1505).

The document data is first acquired based on the schedule information list (F1503). The print device 107 that prints the acquired document data generates print data that can be printed (F1504). In the generation process, a printer driver may be used to generate PDL, or PDF may be used without conversion.

When the generation process of the print data of the schedule information 1000 registered in the job execution list is completed (F1502 to F1505), the transfer of the print data to the print device 107 starts (F1506).

The detailed sequence between the print server 601, the print device 107, the schedule application 801, in which the print server 601 transfers the print data to the print device 107, printing is executed, and notification is made of the printing result, will be described later.

In this way, the print server 601 receives the print instruction from the schedule application 801 and starts transferring the print data to the print device 107 to perform printing.

<Schedule Registration Sequence>

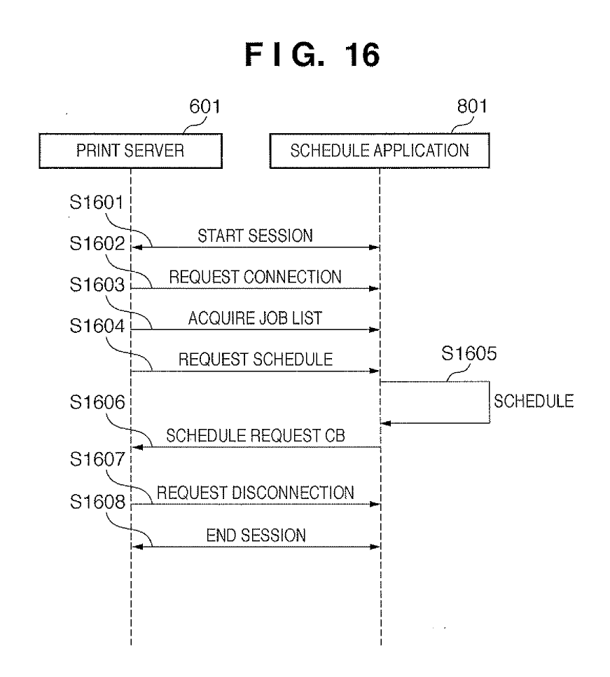

FIG. 16 is a diagram showing a sequence during schedule registration between the print server 601 and the schedule application 801. When the print request is received, the print server 601 registers the schedule in the schedule application 801 in this sequence.

In S1601, a communication session starts between the print server 601 and the schedule application 801. The communication session is established via communication protocols such as TCP/IP and HTTP. In S1602, the print server 601 issues a connection request to the schedule application 801. The communication manager 901 in the schedule application 801 receives the connection request.

In S1603, the list of the schedule information 1000 managed by the job manager 902 of the schedule application 801 is acquired. The acquired list of the schedule information 800 can be used by notifying the list to another application server connected to the print server 601 or by outputting the list to a console that manages the print server 601.

A function of providing the information of print job to the client 108 through the Web server system 102 can also be realized. These functions are not related to the present invention, and the details will not be described.

In S1604, the print server 601 issues a schedule request of print job to the schedule application 801. The schedule request includes the job information 300. After receiving the schedule request, the schedule application 801 registers the schedule in S1605.

After completing the schedule registration, the schedule application 801 returns a schedule request CB to the print server 601 in S1606. The in-device job ID issued upon notification of the schedule registration in the schedule request CB.

The print server 601 issues a disconnection request to the schedule application 801 in S1607 and ends the session established in S1601 in S1608. In this way, the print server 201 can register the schedule in the schedule application 801.

<Print Sequence>

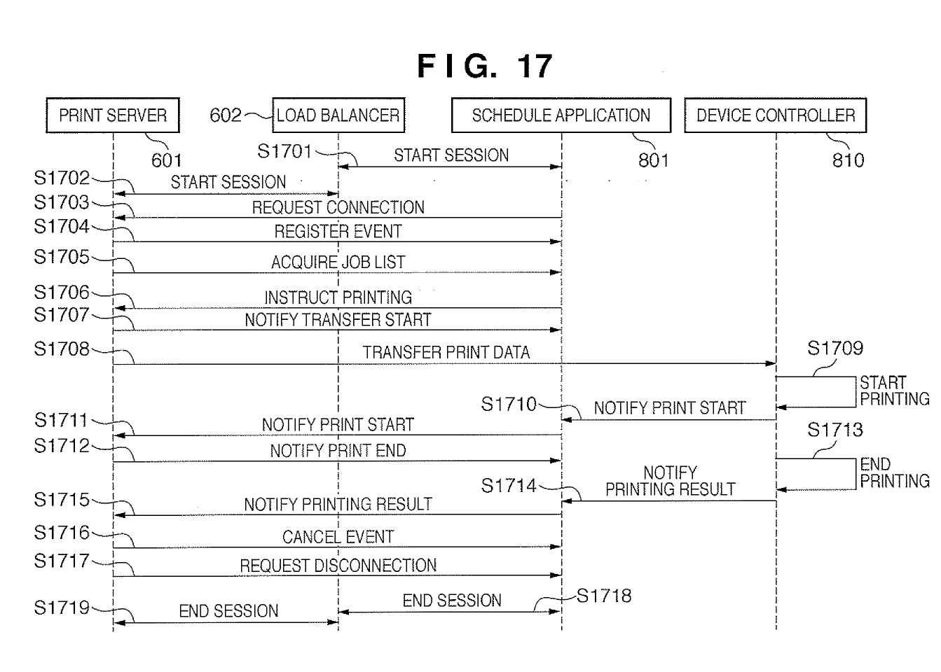

FIG. 17 is a diagram showing a print sequence between the print server 601, the load balancer 602, the schedule application 801, and the device controller 810. The print sequence is a sequence in which the schedule application 801 instructs the print server 601 to print, the print server 601 that has received the print instruction executes a printing process, and the sequence ends.

Since the request destination address 1008 is fixed to the load balancer 602, the load balancer 602 balances the load of the print instructions from the schedule application 801. Although not shown, the event is registered in the device controller 810 upon the activation of the schedule application 801. Therefore, when the print job or the device condition managed by the device controller 810 changes, the schedule application 801 is notified accordingly.

In S1701, a session of communication starts between the load balancer 602 and the schedule application 801. The communication session is established via communication protocols such as TCP/IP and HTTP. In S1702, the load balancer 602 starts the session with the print server 601. The load balancer 602 balances the load of the print server 601 that starts the session. Examples of load balancing methods include round robin, in which requests are simply and sequentially passed to the print servers, and a method of periodically transmitting a specified request to the print servers 601 and determining the time until the reply as the load. The load balancing method depends on the setting of the load balancer 602.

The session of the schedule application 801 and the print server 601 started through the load balancer 602 is maintained in S1718 and S1719 until the session ends. The communications between the schedule application 801 and the print server 601 from S1701 and S1702 to S1718 and S1719 are performed through the load balancer 602.

When the session starts, the schedule application 801 issues a connection request to the print server 601 in S1703. The print server 601 receives the connection request via the device manager 606.

In S1704, the print server 601 registers an event with the schedule application 801 to receive a notification when a print job and a status of print device change. In S1705, a list of the schedule information 1000 currently managed by the job manager 902 of the schedule application 801 is acquired.

The list of the schedule information 1000 acquired here can be used by notifying another application server connected to the print server 601 of the list or by outputting the list to a console that manages the print server 601. A function of providing the print job information to the client 108 through the Web server system 102 can also be realized. These functions are not related to the present invention, and the details will not be described.

In S1706, the schedule application 801 instructs the print server 601 to print. Receiving the print instruction, the print server 601 notifies the schedule application 801 of the start of transfer of the print data in S1707 and starts transferring the print job to the device controller 810 in S1708. The print job is transferred based on the transfer method 404 set in the device information 400. After receiving the start of transfer, the schedule application 801 changes the status 806 of the schedule information 1000 to “transferring”.

Meanwhile, the print data received by the device controller 810 is sequentially analyzed in S1709, and printing starts. In S1710, the schedule application 801 that registers the event is notified of the fact that the status has been changed to “print start”. Having received the print start notification, the schedule application 801 changes the status 1005 of the schedule information 1000 managed by the schedule application 801 to “printing”.

In S1711, the schedule application 801 notifies the print start to the print server 601 that registers the event. In this way, the print server 601 can determine the state of the print job printed by the print server 601. The print server 601 updates the status 306 of the job information 300 held by the DBMS 104.

When the transfer of the print data is completed, the print server 601 notifies the schedule application 801 of the end of transfer in S1712. After receiving the notification, the schedule application 801 changes the status 1005 of the schedule information 1000 of the print job to “transferred” in the same way as when the transfer is started.

Meanwhile, if the printing ends in the print device 107 in S1713, the device controller 810 notifies the schedule application 801 of the printing result in S1714 in the same way as when the printing started. After receiving notification of the printing result, the schedule application 801 notifies the print server 601 of the printing result in S1715.

Having received the printing result, the print server 601 cancels the event for the schedule application 801 in S1716 if printing of all planned print jobs is completed. The print server 601 then issues a disconnection request in S1717.

After receiving the event cancellation and the disconnection request, the schedule application 801 executes an end process of communication with the print server 601. Lastly, the session established in S1701 and S1702 ends in S1718 and S1719.

In this way, the schedule application 801 issues a print instruction to the print server 201 through the load balancer 602, and the print server 201 can print by the print device 107 through the schedule application 801.

<Flow during Job Start of Transfer Notification>

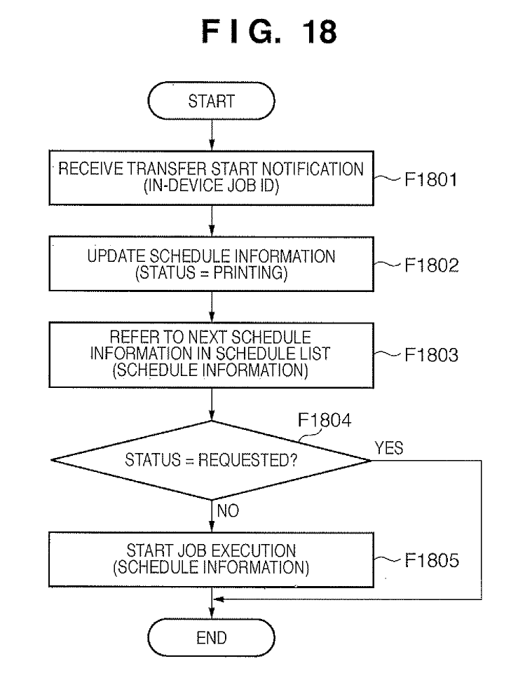

FIG. 18 is a flow chart showing a process of the schedule application 801 when the print server 601 notifies a start of transfer of print data. The schedule application 801 issues a print instruction of the next job of the job started to be transferred at the timing of the notification of the start of transfer of print data.

In S1707 shown in FIG. 17, a start of transfer notification is received from the print server 601 (F1801). The start of transfer notification is performed via the connection established by the connection request in S1703, and the schedule application 801 can specify the in-device job ID of print data started to be transferred. The schedule information 1000 of the schedule list managed by the job manager 902 is specified based on the in-device job ID, and the status 1005 is changed to “printing” (F1802).

The next schedule information of the schedule information notified with the start of transfer is referenced in the schedule list (F1803). Whether the status 1005 of the schedule information is “requested” is then determined (F1804). The job execution starts if the status 1005 is not “requested” (F1805), and the process ends if the status 1005 is “requested”. The job execution start process described above shows details of the job execution start (F1805).

<Printing Result Notification Flow>

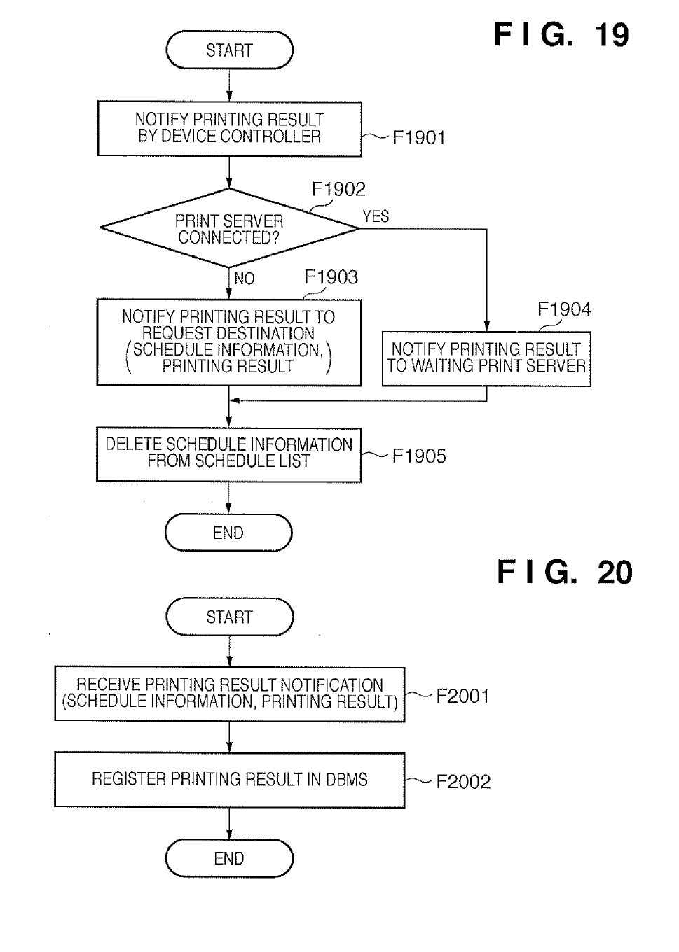

FIG. 19 is a flow chart showing a process when the schedule application 801 receives a printing result from the device controller 810. When the device controller 810 notifies the schedule application 801 of printing result, whether the session with the print server 601 that has started printing is maintained is checked (F1901). If the session with the connected print server 601 that has started printing is maintained, the print server 601 is notified of the printing result (F1904).

On the other hand, if the session with the print server 601 that has started printing is disconnected, a connection with the request destination address 1008 is established, and notification of the printing result is performed (F1903). When the notification of the printing result is completed, the schedule information is deleted from the schedule list (F1905).

In the present embodiment, the address of the load balancer 602 is designated as the request destination address 1008. Therefore, the load balancer 602 balances the load of the printing result notification, and the print server 601 is notified.

FIG. 20 is a flow chart showing a process when a print server 601 receives a printing result notification from the schedule application 801. The print server 601 first receives the printing result notification from the schedule application 801 (F2001). The job information 300 held by the DBMS 104 is specified based on the notified schedule information, and the printing result is registered (F2002).

The load balancer 602 determines the print server 601 that receives the printing result. However, the job information 300 is held as common information in the print servers 601 with cluster configuration in the DBMS 104. Therefore, the print server 601 that registers the printing result is not fixed.

Another print server 601 registers the printing result even if the print server 601 that has started printing and the schedule application 801 are disconnected. Therefore, there is no need to wait for connection recovery. The print server 601 operated by the load balancer 602 is notified of the printing result even if the print server 601 is terminated. Therefore, there is no need to wait for the recovery of the terminated print server 601, and the user can be immediately notified of the printing result.

<Flow During Session Disconnection with Print Server>

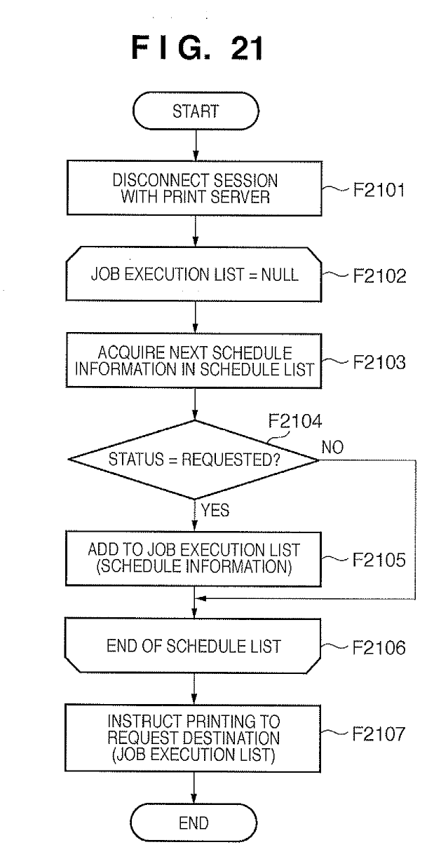

FIG. 21 is a flow chart showing a process of the schedule application 801 when a session disconnection between the print server 601 and the schedule application 801 is detected before notification of the end of transfer.

The schedule application 801 detects a session disconnection with the print server 601 (F2101) and instructs reprinting of the job that the print server 601 disconnected with the session was planning to start printing.

The job execution list necessary for the print instruction is initialized to “NULL” (F2102). All schedule information 1000 registered in the schedule list managed by the schedule application 801 is then processed (F2103 to F2106).

Information, in which the status 1005 is “requested”, in the schedule information 1000 registered in the schedule list is added to the job execution list (F2104 and F2105). When processing of all schedule information 1000 is finished (F2106), printing is instructed to the request destination address 1008 registered in the schedule information 1000 based on the job execution list (F2107).

In the present embodiment, since the address of the load balancer 602 is designated as the request destination address 1008, the load of the print instruction is balanced. Details of the print instruction from the schedule application 801 are as described above.

Even if the session with the print server 601 is disconnected before printing starts and printing cannot be started, printing is executed by instructing printing again. Another print server 601 performs printing when the print server 601 and the schedule application 801 are disconnected. Therefore, there is no need to wait for the recovery of connection with the print server 601 disconnected with the session.

Furthermore, printing is instructed to a print server 601 operated by the load balancer 602 even if a print server 601 is terminated. Therefore, another print server 601 can perform printing without waiting for the recovery of the terminated print server 601.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-277377, filed Oct. 28, 2008, which is hereby incorporated by reference herein in its entirety.

What is claimed is:

1. A printing system that registers a schedule of print jobs and that executes the print jobs in order of registration, the system comprising a print server and a print device, wherein
said print server has a unit that receives a print request of print jobs and requests a print device to register the print jobs, and a unit that abandons the print jobs after the request of the registration of the print jobs;
said print device has a unit that registers the schedule of the print jobs after said print device receives the registration of the print jobs, and a unit that instructs said print server to execute the print jobs according to the schedule; and
said print server further has a unit that acquires the instructed print jobs, generates print data based on the print jobs, and transfers the print data to said print device.

2. The system according to claim 1, wherein
the instruction unit instructs a predetermined print server to execute the print jobs so that said print device consecutively processes the print jobs.

3. The system according to claim 1, further comprising
a unit that distributes instructions of the execution of the print jobs to other print servers with lower load, based on the load condition of said print server.

4. The system according to claim 1, wherein
the instruction unit instructs said print server to execute the print jobs if the number of instructed print jobs is smaller than the maximum number of consecutive print jobs set in said print device.

5. The system according to claim 1, further comprising:
a unit that determines whether said print device and said print server are connected; and
a unit that notifies an address to be notified upon schedule registration of a printing result if it is determined that said print device and said print server are not connected.

6. The system according to claim 1, wherein
said print server further comprises a unit that registers a printing result based on information in a printing result notification.

7. The system according to claim 1, wherein
said print device refers to the schedule registration to determine whether an instruction is issued when the connection with said print server is disconnected and again issues an instruction if the instruction is already issued.

8. A control method of a printing system that registers a schedule of print jobs and that executes the print jobs in order of registration, the method comprising:
receiving, in a print server, a print request of print jobs and requesting a print device to register the print jobs;
abandoning, in the print server, the print jobs after the request of the registration of the print jobs;
registering, in the print device that has received the registration of the print jobs, the schedule of the print jobs;
instruction, by the print device, of said print server to execute the print jobs according to the schedule; and
in the print server, acquiring the instructed print jobs, generating print data based on the print jobs, and transferring the print data to said print device.

9. A program that is recorded in a computer-readable recording medium and that causes a computer to execute the control method of a printing system according to claim 8.

10. A computer-readable recording medium recording a program for causing a computer to execute the control method of a printing system according to claim 8.
